(19) United States
(12) Patent Application Publication
(10) Pub. No.: US 2021/0027797 A1
(43) Pub. Date: Jan. 28, 2021

(54) Telecommunication Device that Provides Improved Understanding of Speech in Noisy Environments

(71) Applicants: Yoram PALTI, Haifa (IL); Boris OKLANDER, Haifa (IL)

(72) Inventors: Yoram PALTI, Haifa (IL); Boris OKLANDER, Haifa (IL)

(21) Appl. No.: 17/071,587

(22) Filed: Oct. 15, 2020

Related U.S. Application Data
(63) Continuation-in-part of application No. 16/847,978, filed on Apr. 14, 2020.
(60) Provisional application No. 62/836,276, filed on Apr. 19, 2019.

(51) Int. Cl. G10L 25/03; G10L 15/20

(52) U.S. Cl. CPC G10L 25/03; G10L 15/20

(57) ABSTRACT

A telecommunication apparatus (e.g., a cell phone) can provide improved understanding of speech in noisy environments by processing incoming audio signals using a digital filter that has at least four audio frequency stop bands, with an audio frequency pass band positioned between adjacent stop bands. Each of the stop bands has a respective center frequency and a respective bandwidth, and the center frequencies of all the stop bands are positioned at regular intervals on a linear scale. The filtered signal is amplified to drive a speaker (e.g., a speaker that is built into the cell phone or incorporated within a set of headphones).

### CROSS REFERENCE TO RELATED APPLICATIONS

This application is a continuation-in-part of the U.S. patent application Ser. No. 16/847,978, filed Apr. 14, 2020, which claims the benefit of U.S. Provisional Application 62/836,276, filed Apr. 19, 2019, which is incorporated herein by reference in its entirety.

### BACKGROUND

Presbycusis or Age Related Hearing Loss (ARHL) is the most common type of hearing loss in the elderly. ARHL is characterized by (1) a loss of hearing sensitivity and (2) a decreased ability to understand speech in the presence of background noise (the “cocktail party effect”). Conventional amplification techniques can be very helpful for overcoming the loss of sensitivity. But conventional techniques have provided a much lower degree of success at overcoming the inability to understand speech.

### SUMMARY OF THE INVENTION

One aspect of the invention is directed to a first hearing assist apparatus. The first hearing assist apparatus comprises a microphone that generates a first signal; and a set of at least four band-stop filters arranged in series. Each of the band-stop filters has a respective center frequency and a respective bandwidth, and the first signal is filtered by each of the at least four band-stop filters in series to yield a second signal. The first hearing assist apparatus also comprises an audio frequency amplifier configured to drive a speaker with an amplified version of the second signal.

In some embodiments of the first hearing assist apparatus, the center frequencies of all the band-stop filters are positioned at regular intervals on a linear scale. In some embodiments of the first hearing assist apparatus, the spacing in frequency between the center frequency of any given band-stop filter and the center frequency of a subsequent band-stop filter is at least two times the bandwidth of the given band-stop filter. In some embodiments of the first hearing assist apparatus, each of the band-stop filters has an order N of at least 6 and a stop band gain that is below −9 dB. In some embodiments of the first hearing assist apparatus, the set of filters has between 8 and 20 band-stop filters arranged in series. Some embodiments of the first hearing assist apparatus further comprise the speaker.

In some embodiments of the first hearing assist apparatus, the center frequencies of all the band-stop filters are positioned at regular intervals on a linear scale, and the size of the regular intervals is user-adjustable. Optionally, in these embodiments, each of the band-stop filters has the same bandwidth B, and B is user-adjustable. Optionally, in these embodiments, the set of filters has between 8 and 20 band-stop filters arranged in series.

Another aspect of the invention is directed to a second hearing assist apparatus. The second hearing assist apparatus comprises a microphone that generates a first signal; and a digital filter having at least four audio frequency stop bands, with an audio frequency pass band positioned between adjacent stop bands. Each of the stop bands has a respective center frequency and a respective bandwidth, and the digital filter inputs the first signal and generates a corresponding filtered second signal as an output. The second hearing assist apparatus also comprises an audio frequency amplifier configured to drive a speaker with an amplified version of the second signal.

In some embodiments of the second hearing assist apparatus, the center frequencies of all the stop bands are positioned at regular intervals on a linear scale. In some embodiments of the second hearing assist apparatus, the spacing in frequency between the center frequency of any given stop band and the center frequency of a subsequent stop band is at least two times the bandwidth of the given stop band. In some embodiments of the second hearing assist apparatus, each of the stop bands has an order N of at least 6 and a stop band gain that is below −9 dB. In some embodiments of the second hearing assist apparatus, the digital filter has between 8 and 20 stop bands. Some embodiments of the second hearing assist apparatus further comprise the speaker.

In some embodiments of the second hearing assist apparatus, the center frequencies of all the stop bands are positioned at regular intervals on a linear scale, and the size of the regular intervals is user-adjustable. Optionally, in these embodiments, each of the stop bands has the same bandwidth B, and B is user-adjustable. Optionally, in these embodiments, the digital filter has between 8 and 20 stop bands.

Another aspect of the invention is directed to a first method of processing an audio signal to assist a person's hearing. The first method comprises inputting the audio signal; and filtering the audio signal using a filter that has between 8 and 20 audio frequency stop bands, with an audio frequency pass band positioned between adjacent stop bands. Each of the stop bands has a respective center frequency and a respective bandwidth, and each of the stop bands has an order N of at least 6 and a stop band gain that is below −9 dB. The first method also comprises generating an output signal based on the filtered audio signal.

In some instances of the first method, the center frequencies of all the stop bands are positioned at regular intervals on a linear scale. In some instances of the first method, the spacing in frequency between the center frequency of any given stop band and the center frequency of a subsequent stop band is at least two times the bandwidth of the given stop band. In some instances of the first method, the center frequencies of all the stop bands are positioned at regular intervals on a linear scale, and the size of the regular intervals is user-adjustable.

Another aspect of the invention is directed to a third telecommunication apparatus. The third telecommunication apparatus comprises a first processor configured to convert a microphone output signal to outgoing data; and a transceiver configured to transmit the outgoing data and to receive incoming data. The third telecommunication apparatus also comprises a second processor configured to (a) extract a first signal from the incoming data and (b) process the first signal using a digital filter and generate a corresponding filtered second signal as an output. The digital filter has at least four audio frequency stop bands, with an audio frequency pass band positioned between adjacent stop bands. Each of the stop bands has a respective center frequency and a respective bandwidth. The third telecommunication apparatus also comprises an audio frequency amplifier configured to drive a speaker with an amplified version of the second signal. The third telecommunication apparatus also comprises a controller programmed to output an audio signal that corresponds to a set of words to the digital filter for processing, and accept a user adjustment of parameters of the digital filter that provides the user with improved intelligibility.

In some embodiments of the third telecommunication apparatus, the controller, the first processor, and the second processor are all implemented in a single integrated circuit. In some embodiments of the third telecommunication apparatus, added noise is included in the audio signal that corresponds to the set of words. In some embodiments of the third telecommunication apparatus, the center frequencies of all the stop bands are positioned at regular intervals on a linear scale.

Another aspect of the invention is directed to a second method of processing an audio signal to assist a person's hearing. The second method comprises generating a first audio signal that corresponds to a given set of words; and filtering the first audio signal using a digital filter that has between 8 and 20 audio frequency stop bands, with an audio frequency pass band positioned between adjacent stop bands. Each of the stop bands has a respective center frequency and a respective bandwidth. The second method also comprises outputting the filtered version of the first audio signal to a user; accepting, from the user, at least one adjustment to a set of parameters for the digital filter; and storing a set of user-preferred parameters for the digital filter based on the accepting step. The second method also comprises inputting a second audio signal; filtering the second audio signal using the digital filter, using the stored set of user-preferred parameters; and generating an output signal based on the filtered second audio signal.

In some instances of the second method, added noise is included in the first audio signal. In some instances of the second method, the center frequencies of all the stop bands are positioned at regular intervals on a linear scale. In some instances of the second method, a spacing in frequency between the center frequency of any given stop band and the center frequency of a subsequent stop band is at least two times the bandwidth of the given stop band. In some instances of the second method, the center frequencies of all the stop bands are positioned at regular intervals on a linear scale, and a size of the regular intervals is user-adjustable. In some instances of the second method, each of the stop bands has an order N of at least 6 and a stop band gain that is below −9 dB.

Another aspect of the invention is directed to a fourth telecommunication apparatus. The fourth telecommunication apparatus comprises a first processor configured to convert a microphone output signal to outgoing data; and a transceiver configured to transmit the outgoing data and to receive incoming data. The fourth telecommunication apparatus also comprises a second processor configured to (a) extract a first signal from the incoming data and (b) process the first signal using a digital filter and generate a corresponding filtered second signal as an output. The digital filter has at least four audio frequency stop bands, with an audio frequency pass band positioned between adjacent stop bands. Each of the stop bands has a respective center frequency and a respective bandwidth, and the center frequencies of all the stop bands are positioned at regular intervals on a linear scale. And the fourth telecommunication apparatus also comprises an audio frequency amplifier configured to drive a speaker with an amplified version of the second signal.

In some embodiments of the fourth telecommunication apparatus, a spacing in frequency between the center frequency of any given stop band and the center frequency of a subsequent stop band is at least two times the bandwidth of the given stop band. In some embodiments of the fourth telecommunication apparatus, each of the stop bands has an order N of at least 6 and a stop band gain that is below −9 dB. In some embodiments of the fourth telecommunication apparatus, the digital filter has between 8 and 20 stop bands.

In some embodiments of the fourth telecommunication apparatus, a size of the regular intervals is user-adjustable. Optionally, in these embodiments, each of the stop bands may have the same bandwidth B, where B is user-adjustable.

Some embodiments of the fourth telecommunication further comprise the speaker. Some embodiments of the fourth telecommunication further comprise a microphone that generates the microphone output signal.

### BRIEF DESCRIPTION OF THE DRAWINGS

FIG. 1 is a block diagram of a system that improves a user's ability to understand speech.

FIG. 2 is a frequency response plot for a successful example of the digital filter depicted in FIG. 1.

FIG. 3 is an example of a graphical user interface that may be used to implement the user interface depicted in FIG. 1.

FIG. 4 depicts the frequency content of the noise that was used to test the system.

FIG. 5 is a frequency response plot for an unsuccessful example of the digital filter depicted in FIG. 1.

FIGS. 6A-6D show how the human ear's responsiveness to frequency varies with position within the cochlea.

FIG. 7 schematically depicts tuning curves at six different positions within the cochlea of a non-impaired ear.

FIG. 8 schematically depicts the widening of the tuning curves that is associated with ARHL.

FIG. 9 is a simplified schematic block diagram of a prior art cellular phone.

FIG. 10 is a simplified schematic block diagram of a cellular phone that improves a user's ability to understand speech

Various embodiments are described in detail below with reference to the accompanying drawings, wherein like reference numerals represent like elements.

### DESCRIPTION OF THE PREFERRED EMBODIMENTS

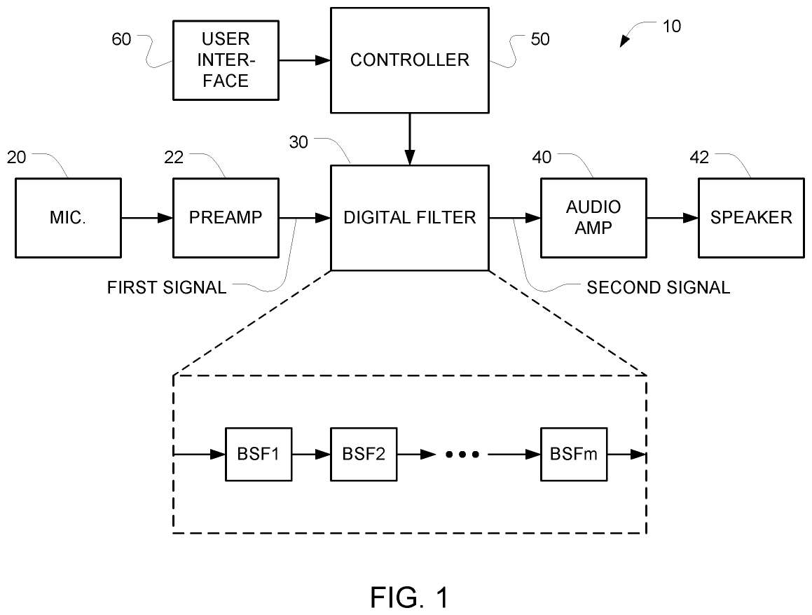

FIG. 1 is a block diagram of a system that has proven to be useful in improving users' ability to understand speech. As in a conventional hearing aid, the system 10 has a microphone 20 that converts sound waves into electricity and a preamplifier 22. And as in a conventional hearing aid, the system 10 has an audio amplifier 40 that drives a speaker 42. And as in conventional hearing aids, the microphone 20 and the speaker 42 may optionally be implemented using a single transducer. But unlike conventional hearing aids, the system 10 has a digital filter 30 that accepts a signal from the microphone (also referred to herein as a first signal), processes that signal using the specific digital filtering techniques described below, and generates an output signal (also referred to herein as a second signal) that is provided to the audio amplifier.

The digital filter 30 implements m band-stop filters BSF1, BSF2, . . . BSFm connected in series, where m is at least 4.

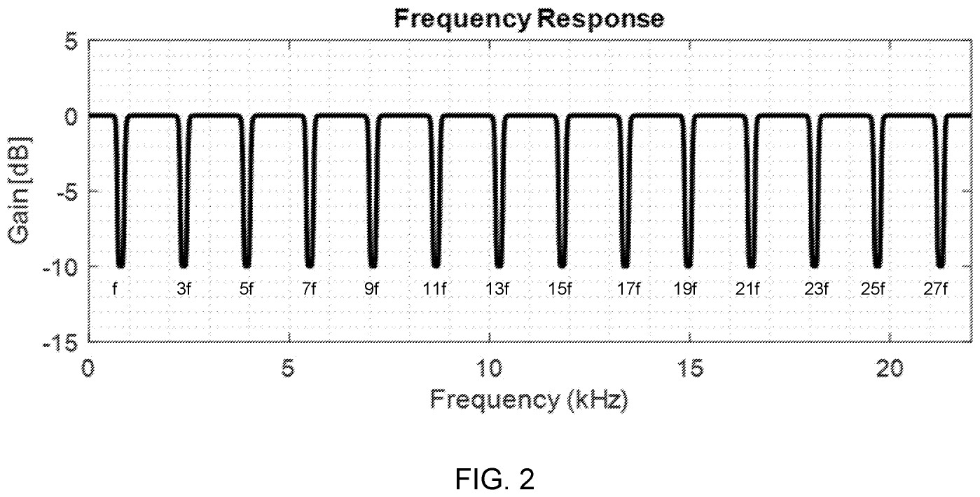

FIG. 2 is a frequency response plot (not to scale) for one example of the digital filter 30 for the situation where m=14. In this example, there are 14 band-stop filters BSF1 through BSF14 arranged in series. Each of these band-stop filters will form a corresponding stop band with a respective center frequency and a respective bandwidth. In this example, each of the 14 stop bands has the same bandwidth B, and the center frequencies of all the stop bands are positioned at regular intervals on a linear scale. More specifically, in the example depicted in FIG. 2, each of the 14 stop bands has a bandwidth B of 735 Hz; the first center frequency f1 is positioned at 787.5 Hz; the center frequencies of the stop bands are positioned at regular intervals of 1575 Hz; the gain in each of the stop bands is −10 dB; and the order N of each of the band-stop filters BSF1 through BSF14 is 16. When this set of parameters is used, the spacing between the center frequencies of any given band-stop filter and its next higher-frequency neighbor will be at least two times the bandwidth of the given band-stop filter.

Experimental testing revealed that filtering using the particular set of parameters identified in the previous paragraph provided improved understandability of speech for most members of a group of test subjects. This experimental testing was accomplished using digital signal processing algorithm software running on a personal computer (PC) to implement a set of m band-stop filters arranged in series, with the center frequencies of all the stop bands positioned at regular intervals on a linear scale. The software was programmed to vary m, the bandwidth B of the stop bands, the spacing between the center frequencies of the stop bands, the gain in the stop bands, and the order N of each of the band-stop filters based on inputs received from users via a user interface.

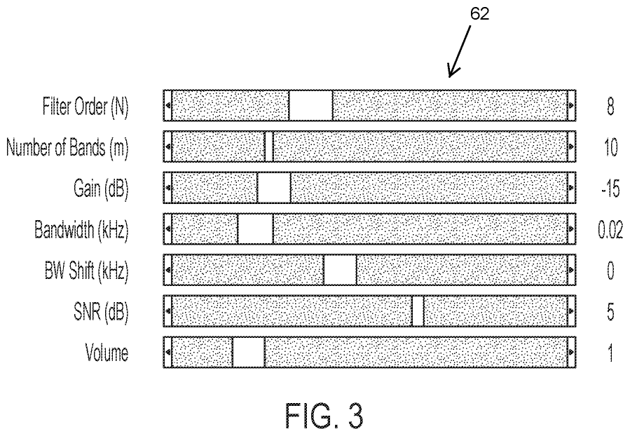

FIG. 3 is an example of a graphical user interface 62 that was used for this purpose on the PC, with the relevant parameters being controlled by the user by adjusting the horizontal position of the sliders.

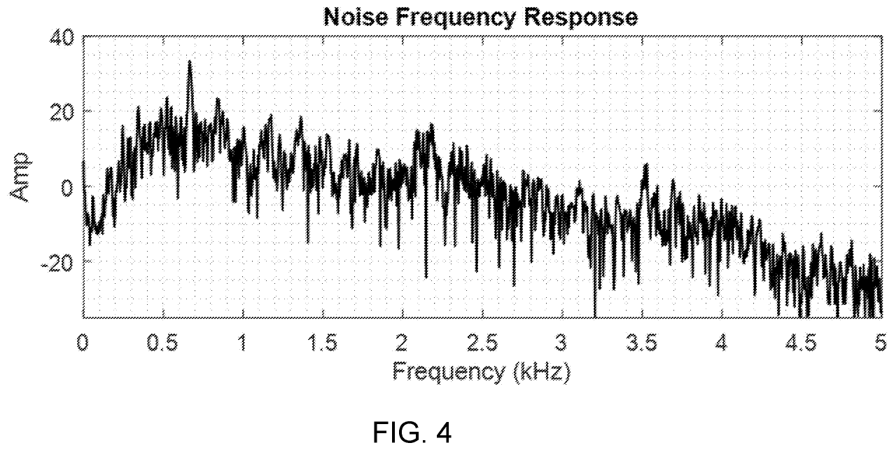

In the experiments, a group of individuals with relevant hearing impairments listened to a recording of a clean speech to which noise was added. The added noise was “cocktail party” type noise, which is a background noise that one would encounter in busy public places such as a busy restaurant, and FIG. 4 depicts the frequency content of this “cocktail party” type noise between 0 and 5 kHz.

The signal to noise ratio (SNR) was controllable. After the SNR was set to a value at which a given test subject could not understand the speech when the digital filter was turned off, The test subjects were given access to a GUI similar to the one depicted in FIG. 3, and the test subjects were able to change the various filter parameters identified above through the GUI while listening to a filtered version of the speech+noise. A GUI button was also provided to switch the digital filter in or out (i.e., on or off), which made it easier for the test subjects to compare the unfiltered version of the speech+noise to the filtered version. The test subjects reported when a set of filtering parameters resulted in improved understanding of the speech. Sets of settings that provided improved understanding for most of the group were identified, and one example of a set of settings that provided improved understanding is described above in connection with FIG. 2. When this set of settings was used for implementing the digital filter 30 (shown in FIG. 1), the test subjects reported significant improvement in their ability to understand the words/content of the speech when the speech+noise was processed by the filter (as compared to when the same speech+noise was heard without applying the filter).

Sets of parameters for the digital filter that provided improved ability to understand speech were found within the following ranges: filter order N of at least six; number of band-stop filters m between 8 and 20; and stopband gain below −9 dB.

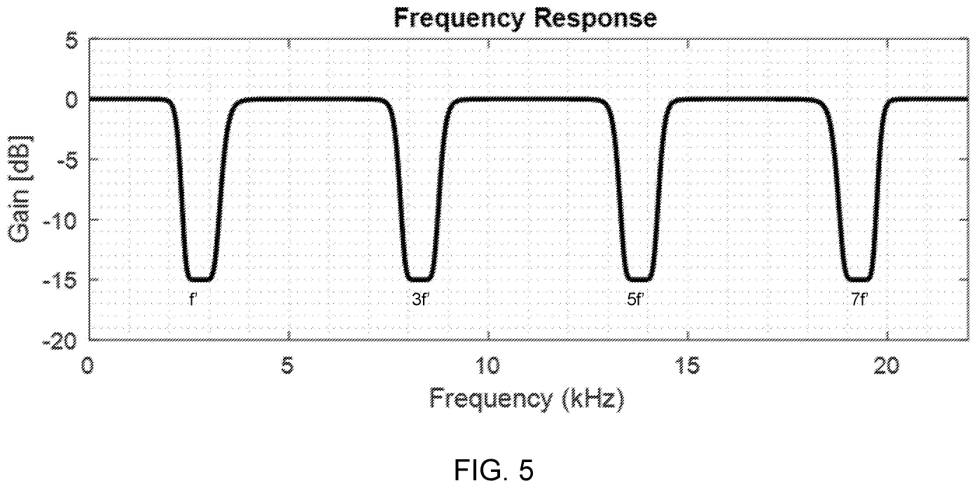

By way of comparison, when the GUI depicted in FIG. 3 was used to set the digital filter parameters on the PC so as to generate the frequency response plot depicted in FIG. 5, understanding of the speech was not improved to a significant degree. In this unsuccessful example, m was set to 4, which means that there were 4 band-stop filters BSF1 through BSF4 arranged in series. Each of those 4 band-stop filters resulted in a corresponding stop band at f′, 3f′, 5f′, and 7f′, where f′ was 2756.25 Hz (with the spacing between consecutive stop bands being 5512.5 Hz). Each of these stop bands had a bandwidth of 2 kHz and a gain of −15 dB, and the order N of each of the band-stop filters BSF1 through BSF4 was 16.

Returning to FIG. 1, in the context of the experimental testing described above, the user interface 60, the controller 50, and the digital filter 30 were all implemented in the PC. In alternative embodiments, the digital filtering algorithms described above may be implemented as an app on a smart phone, in which case the microphone 20, audio amplifier 40, and speaker 42 could be implemented using the microphone, audio amplifier, and earphones of the smart phone; the digital filter 30 and controller 50 could be implemented using the phone's microprocessor; and the user interface 60 could be implemented using the phone's user interface.

In alternative embodiments, the system (including components 20-50) is miniaturized to the size of a hearing aid that rests on or in the user's ear, and the digital filtering algorithms described above are implemented by a digital signal processor (DSP) chip incorporated within the miniaturized system. In these embodiments, the DSP chip can perform the functions of both the digital filter 30 and the controller 50. Alternatively, the DSP chip can perform the functions of the digital filter 30 only, and a separate integrated circuit can perform the functions of the controller 50. In these miniaturized embodiments, the user interface 60 may be implemented using an app on a smart phone that communicates with the controller 50 using any conventional communication approach (e.g., Bluetooth). Of course, a wide variety of alternative user interfaces 60 can be readily envisioned, including but not limited to a set of dials and/or switches that can be actuated by the user to adjust the parameters of the digital filter 30.

In some embodiments, the entire system depicted in FIG. 1 is provided to the end user, including the user interface 60. In these embodiments the end-user has the ability to modify the parameters of the digital filter 30 to improve recognition of speech via the user interface 60. For example, the user could select a first set of parameters for the digital filter 30 when the user finds themselves in a first environment (e.g., a restaurant), and subsequently select a second set of parameters for the digital filter 30 when the user finds themselves in a second environment (e.g., a busy street). Optionally, when the user finds a set of parameters that works well in a particular environment, the user can save those parameters (e.g., by clicking a “store” button on a user interface) so that the preferred set of parameters can be retrieved quickly. The user interface can also provide the ability to store (and optionally name) two or more sets of preferred parameters for quick retrieval. The system depicted in FIG. 1 can be used to improve intelligibility both when background noise is present and in quiet environments. So one of the stored sets of parameters can be dedicated to quiet environments.

Optionally, the controller 50 can be programmed to implement a “training mode” to help any given user specify a set of parameters for the digital filter 30 that works best for that user. One suitable approach for implementing this training mode is to program the controller 50 to output an audio signal corresponding to a given set of words (e.g., using a prerecorded audio file or text-to-speech), and to send that audio signal into the digital filter 30 for processing and subsequent output to the user (e.g., via the audio amplifier 40 and the speaker 42). The first time a user uses the system, the user is prompted (e.g., via the user interface 60) to adjust the set of parameters and to indicate when good intelligibility is achieved while the set of words are being output (and, if necessary, repeated). The controller 50 and the user interface 60 may be programmed to accept indications of intelligibility using any of a variety of alternative approaches (including but not limited to pressing a single user interface button to indicate when intelligibility is good, ranking intelligibility on a scale of 1-10, etc.). The controller 50 saves the parameters that correspond to good intelligibility in memory for subsequent retrieval.

Optionally, noise may be added to the audio signal corresponding to the given set of words while the given set of words is being output to the user during the training mode, and the level of the noise (with respect to the signal) may be user-adjustable. Optionally, the controller 50 may be programmed to give the user the ability to repeat the training mode on demand.

Whenever the system is subsequently used, the digital filter 30 uses the stored set of parameters when processing incoming audio data. More specifically, the system will input incoming audio signals, filter those incoming audio signals using the digital filter 30 using the stored set of parameters, and output a filtered version of the incoming audio signals.

In some embodiments, the user interface 60 allows the user to control all of the parameters described above. (See, e.g., the GUI 62 depicted in FIG. 3.) But in alternative embodiments, the user interface 60 may only allow the user to control a subset of those parameters in order to simplify the user interface. In one example, the user could be provided with a user interface that provides access to only a single variable such as the spacing between the center frequencies of the band-stop filters. Assuming that the digital filter positions the center frequencies of all the band-stop filters at regular intervals on a linear scale, adjusting this single variable would still provide a significant degree of controllability to the user. In another example, the user could be provided with a user interface that provides access to only two variables: (1) the spacing between the center frequencies of the band-stop filters, and (2) the bandwidth of each of the band-stop filters. In these embodiments, the remaining variables (e.g., the order N of the filters and the gain in the stop band) can remain constant (e.g., by leaving the order of the filters fixed at 16 and setting the gain in the stop band to −10 dB). A wide variety of alternative user interfaces can be readily envisioned.

In other embodiments, use of the user interface 60 is restricted to a practitioner (e.g. an audiologist), and the user interface 60 is not provided to the end-user. In these embodiments, the audiologist could set the parameters for the digital filter 30 during an office visit, and those parameters would remain in force until such time that they are updated by the audiologist. In still other embodiments, after a suitable set of parameters for the digital filter 30 has been identified, those parameters could be hardcoded into a dedicated digital filter, in which case the controller 50 can be omitted from the device that is worn by the user.

Note that in the examples noted above, the center frequencies of all the band-stop filters were positioned at regular intervals on a linear scale. But in alternative embodiments, the center frequencies of all the band-stop filters could be positioned at regular intervals on a logarithmic scale or at irregular intervals.

The results described herein may seem counterintuitive because filtering the signal+noise using a set of at least four band-stop filters arranged in series discards a significant portion of the signal, and because the noise is not arriving at a known frequency. For example, when the digital filter parameters described above in connection with FIG. 2 are used, portions of the signal that reside in the stop bands depicted in FIG. 2 are suppressed. Nevertheless, real-world testing has shown that using the filters described herein can significantly improve user's ability to understand speech in noisy environments.

Without being bound or limited by this theory, one possible explanation of why introducing a plurality of stop bands to the frequency response that arrives at the user's ears improves the user's ability to understand speech in noisy environments is as follows.

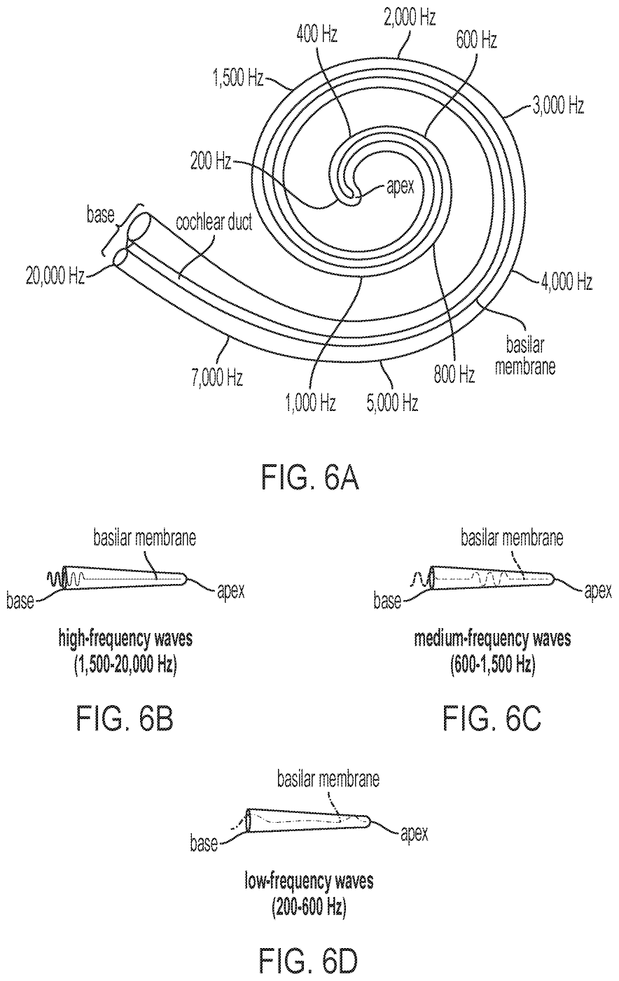

Sound sensation is based on the vibration induced by sound waves in the structures of the inner ear (e.g., the cochlea). The hair cells residing on the vibrating base membrane are responsible for the actual transduction of the mechanical pressure waves into neural signals. The amplitude of base membrane response is a function of the sound wave frequency (in the audio range) in a unique way: the response is location selective, i.e. the response at the basal part of the membrane is limited mostly to high frequencies and the responsiveness to low frequencies increases with distance from the base as seen in FIGS. 6A-6D.

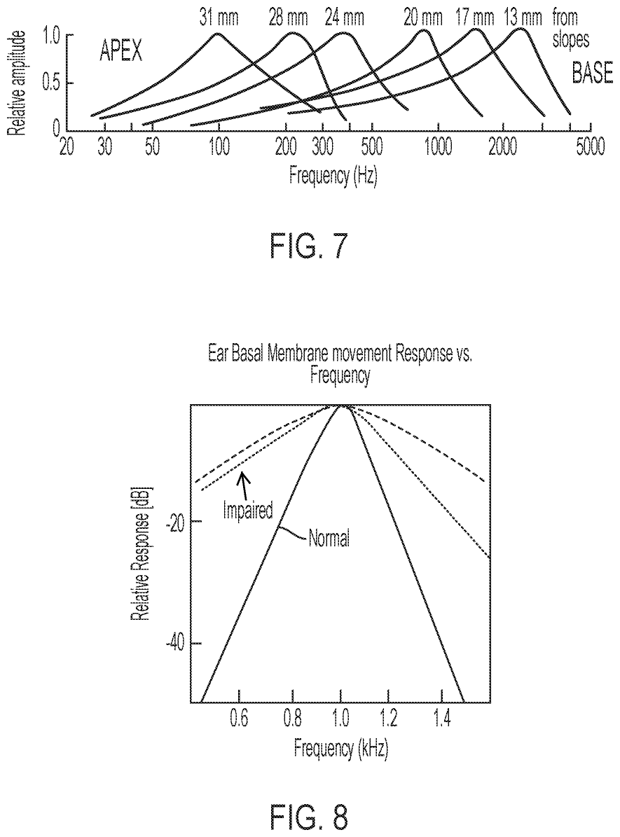

The net effect is a bell-shaped response vs. frequency curve (tuning curve), that is somewhat asymmetric, as illustrated schematically in FIG. 7. An important characteristic of these response curves is the significant frequency overlap of the tuning curves. This overlap can affect the discriminatory power of the auditory system. Moreover, these tuning curves undergo significant changes in some hearing impairments, mainly in the highly prevalent hearing loss with age (presbycusis). The main changes are an overall reduction of sensitivity and a significant asymmetric widening of each curve, as indicated schematically in FIG. 8. More specifically, FIG. 8 shows the relatively narrow frequency response curve for a normal ear (shown in solid lines) and the relatively wider frequency response curves for two impaired ears (shown in dashed and dotted lines). This pathology, which is manifested in increased overlap of the tuning curves, results in a significant reduction of the auditory discriminatory power and consequently, impairment of the ability to understand speech in noisy environments. The inventors theorized that adding the band-stop filters as described herein may shrink the range of audio frequencies that arrive at any given hair cell (or set of hair cells), thereby artificially creating the equivalent of a narrower tuning curve and improving user's ability to understand speech.

A similar approach of using at least four band-stop filters may also be applied in the context of a cellular phone.

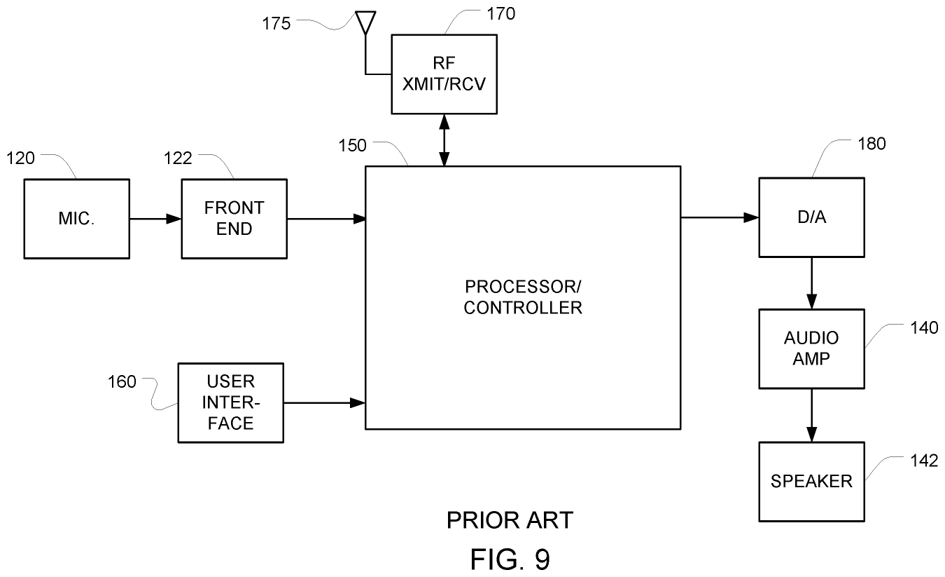

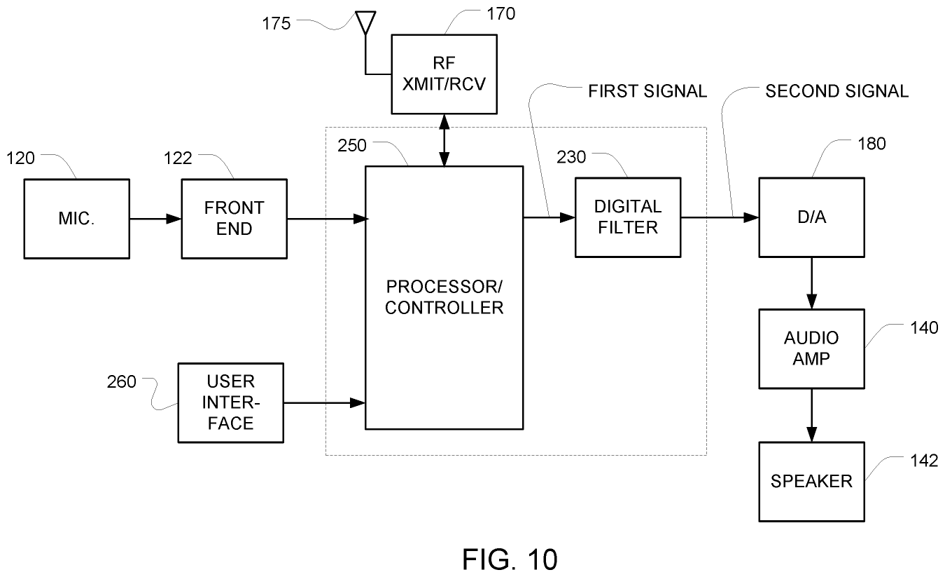

To understand these embodiments, it will be helpful to first review the operation of a conventional prior art cellular phone. FIG. 9 depicts a simplified block diagram of a prior art cellular phone. Outgoing communications involve the microphone 120 (which picks up the user's voice), a front end 122 (which reformats the output of the microphone 120), a processor controller 150 (which processes the user's voice signals), an RF transceiver 170, and an antenna 175. The design and operation of these components 120, 122, 150, 170, and 175 will be apparent to persons skilled in the relevant arts. Incoming communications involve the antenna 175 and the RF transceiver 170 (which, collectively, receive incoming communications), the processor/controller 150 (which processes the incoming signals that arrive at the transceiver 170), a digital-to-analog converter 180 (which converts the processor/controller's digital output to an analog signal), an audio amplifier 140, and a speaker 142. A suitable user interface 160 is also provided. The design and operation of these components 175, 170, 150, 180, 140, and 142, and 160 will also be apparent to persons skilled in the relevant arts.

FIG. 10 depicts an embodiment that uses at least four band-stop filters to perform audio processing in the context of a cellular phone to improve intelligibility. Outgoing communications in this embodiment are handled in the same way as outgoing communications in the FIG. 9 example above. More specifically, outgoing communications involve the microphone 120 (which picks up the user's voice), a front end 122 (which reformats the output of the microphone 120), a processor controller 250 (which processes the user's voice signals in a manner similar to the processor/controller 150 described above, and converts the microphone output signal to outgoing data. The RF transceiver 170 is configured to transmit this outgoing data via the antenna 175. The design and operation of components 120, 122, 170, and 175 will be apparent to persons skilled in the relevant arts, and can be identical to the corresponding components in the FIG. 9 example described above. In this embodiment, the processor/controller 250 is programmed to handle outgoing communications in the same way as the prior art processor/controller 150 in the FIG. 9 example described above.

Incoming communications, on the other hand, are handled differently in the FIG. 10 embodiment. More specifically, incoming communications involve the antenna 175 and the RF transceiver 170 (which, collectively, receive incoming communications and operate in the same way as the FIG. 9 example above), and the processor/controller 250 (which processes the incoming signals that arrive at the transceiver 170).

In some embodiments (referred to herein as option A), the processor/controller 250 is programmed to handle incoming communications in the same way as the processor/controller 150 described above in connection with the FIG. 9 example. In these embodiments, after the processor 250 extracts a first signal (which corresponds to audio) from the incoming data, the first signal is provided to a digital filter 230. The digital filter 230 in these embodiments has the same characteristics as the digital filter 30 in the FIG. 1 embodiments described above, and the digital filter 230 outputs a second signal. The digital filter 230 may be implemented in hardware that is separate from the processor/controller 250. Alternatively, the processor/controller 250 and the digital filter 230 may both be implemented in a single integrated circuit that is programmed to perform the functions of both a controller and a digital filter. Note that the processor/controller 250 may use a first processor for outgoing communications and a second processor for incoming communications. Alternatively, a single hardware device (e.g., a microprocessor) may serve as both the first processor for outgoing communications and the second processor for incoming communications.

In other embodiments (referred to herein as option B), the processor/controller 250 is programmed to generate the second signal (i.e., the filtered signal) directly from the data that arrives from the transceiver 170 without ever outputting the unfiltered first signal that corresponds to the incoming communications. In these embodiments, the functionality of the processor/controller 250 and the digital filter 230 is preferably combined into a single integrated circuit, in which case the digital filter 230 could be implemented as an object that is executed by the processor/controller 250 (as opposed to a discrete device).

Regardless of whether option A or option B is used, the transceiver 170 receives incoming data, and the processor/controller 250 and the digital filter 230 collectively extract a first signal from the incoming data and process the first signal using a digital filter to generate a corresponding filtered second signal as an output. The digital filter has at least four audio frequency stop bands, with an audio frequency pass band positioned between adjacent stop bands. Each of the stop bands has a respective center frequency and a respective bandwidth, and the center frequencies of all the stop bands are positioned at regular intervals on a linear scale.

Whichever approach is used to generate the second signal (i.e., the filtered signal), the second signal is provided to a digital-to-analog converter 180, which converts the processor/controller's digital output to an analog signal. The analog signal is provided to an audio amplifier 140, which generates an amplified analog version of the second signal that is used to drive the speaker 142. The construction and operation of these components 180, 140, 142 is the same as in the FIG. 9 example. Note that the speaker may be provided in a separate housing, including but not limited to speakers positioned within wired and wireless headphones. When headphones are utilized, noise isolating or noise canceling headphones may be preferable.

Optionally, a training mode similar to the training mode discussed above in connection with FIG. 1 may be implemented in this FIG. 10 embodiment.

While the present invention has been disclosed with reference to certain embodiments, numerous modifications, alterations, and changes to the described embodiments are possible without departing from the sphere and scope of the present invention, as defined in the appended claims. Accordingly, it is intended that the present invention not be limited to the described embodiments, but that it has the full scope defined by the language of the following claims, and equivalents thereof.

What is claimed is:

1. A telecommunication apparatus comprising:
a first processor configured to convert a microphone output signal to outgoing data;
a transceiver configured to transmit the outgoing data and to receive incoming data;
a second processor configured to (a) extract a first signal from the incoming data and (b) process the first signal using a digital filter and generate a corresponding filtered second signal as an output, wherein the digital filter has at least four audio frequency stop bands, with an audio frequency pass band positioned between adjacent stop bands, each of the stop bands having a respective center frequency and a respective bandwidth;
an audio frequency amplifier configured to drive a speaker with an amplified version of the second signal; and
a controller programmed to output an audio signal that corresponds to a set of words to the digital filter for processing, and accept a user adjustment of parameters of the digital filter that provides the user with improved intelligibility.

2. The apparatus of claim 1, wherein the controller, the first processor, and the second processor are all implemented in a single integrated circuit.

3. The apparatus of claim 1, wherein added noise is included in the audio signal that corresponds to the set of words.

4. The apparatus of claim 1, wherein the center frequencies of all the stop bands are positioned at regular intervals on a linear scale.

5. A method of processing an audio signal to assist a person's hearing, the method comprising:
generating a first audio signal that corresponds to a given set of words;
filtering the first audio signal using a digital filter that has between 8 and 20 audio frequency stop bands, with an audio frequency pass band positioned between adjacent stop bands, each of the stop bands having a respective center frequency and a respective bandwidth;
outputting the filtered version of the first audio signal to a user;
accepting, from the user, at least one adjustment to a set of parameters for the digital filter;
storing a set of user-preferred parameters for the digital filter based on the accepting step;
inputting a second audio signal;
filtering the second audio signal using the digital filter, using the stored set of user-preferred parameters; and
generating an output signal based on the filtered second audio signal.

6. The method of claim 5, wherein added noise is included in the first audio signal.

7. The method of claim 5, wherein the center frequencies of all the stop bands are positioned at regular intervals on a linear scale.

8. The method of claim 5, wherein a spacing in frequency between the center frequency of any given stop band and the center frequency of a subsequent stop band is at least two times the bandwidth of the given stop band.

9. The method of claim 5, wherein the center frequencies of all the stop bands are positioned at regular intervals on a linear scale, and wherein a size of the regular intervals is user-adjustable.

10. The method of claim 5, wherein each of the stop bands has an order N of at least 6 and a stop band gain that is below −9 dB.

11. A telecommunication apparatus comprising:
a first processor configured to convert a microphone output signal to outgoing data;
a transceiver configured to transmit the outgoing data and to receive incoming data;
a second processor configured to (a) extract a first signal from the incoming data and (b) process the first signal using a digital filter and generate a corresponding filtered second signal as an output, wherein the digital filter has at least four audio frequency stop bands, with an audio frequency pass band positioned between adjacent stop bands, each of the stop bands having a respective center frequency and a respective bandwidth, and wherein the center frequencies of all the stop bands are positioned at regular intervals on a linear scale; and
an audio frequency amplifier configured to drive a speaker with an amplified version of the second signal.

12. The apparatus of claim 11, wherein a spacing in frequency between the center frequency of any given stop band and the center frequency of a subsequent stop band is at least two times the bandwidth of the given stop band.

13. The apparatus of claim 11, wherein each of the stop bands has an order N of at least 6 and a stop band gain that is below −9 dB.

14. The apparatus of claim 11, wherein the digital filter has between 8 and 20 stop bands.

15. The apparatus of claim 11, wherein a size of the regular intervals is user-adjustable.

16. The apparatus of claim 15, wherein each of the stop bands has the same bandwidth B, and wherein B is user-adjustable.

17. The apparatus of claim 11, further comprising the speaker.

18. The apparatus of claim 11, further comprising a microphone that generates the microphone output signal.
